(19) United States
(12) Patent Application Publication
(10) Pub. No.: US 2017/0187982 A1
(43) Pub. Date: Jun. 29, 2017

(54) METHOD AND TERMINAL FOR PLAYING CONTROL BASED ON FACE RECOGNITION

(71) Applicants: Le Holdings (Beijing) Co., Ltd., Beijing (CN); Le Shi Zhi Xin Electronic Technology (Tianjin) Limited, Tianjin (CN)

(72) Inventor: Feng Pan, Binhai New Area (CN)

(21) Appl. No.: 15/240,227

(22) Filed: Aug. 18, 2016

Related U.S. Application Data
(63) Continuation of application No. PCT/CN2016/089582, filed on Jul. 10, 2016.

(30) Foreign Application Priority Data
Dec. 29, 2015 (CN) 201511014703.0

(51) Int. Cl. H04N 5/783; G06T 7/20; G11B 27/36; G06K 9/00

(52) U.S. Cl. CPC H04N 5/783; G06K 9/00248; G06K 9/00261; G06T 7/20; G11B 27/36; G06T 2207/10016; G06T 2207/30201

(57) ABSTRACT

Embodiments of this application disclose a playing control method and playing terminal based on face recognition, where the playing control method includes: collecting a face image; analyzing the face image, and extracting a central position of a face in the face image; comparing the current central position and an initial central position before a first time interval to obtain a movement displacement; determining whether the movement displacement is great than a preset displacement threshold; and pausing a current video playing process if it is determined that the movement displacement is great than the preset displacement threshold. According to the playing control method and playing terminal based on face recognition provided in some embodiments of this application, a watching position of a user is determined by monitoring a displacement and turning of a face, and after it is detected that the user leaves a normal watching position, playing of a video file is paused, which thereby implements an automatic control process for video playing, and provides convenience for the video user.

### CROSS-REFERENCE TO RELATED APPLICATIONS

The present disclosure claims priority to Chinese Patent Application No. 201511014703.0, filed with the Chinese Patent Office on Dec. 29, 2015 and entitled “PLAYING CONTROL METHOD AND PLAYING TERMINAL BASED ON FACE RECOGNITION”, which is incorporated herein by reference in its entirety.

### TECHNICAL FIELD

The present disclosure relates to the field of multimedia control technologies, and in particular, to a playing control method and playing terminal based on face recognition.

### BACKGROUND

During playing of a video file, an existing playing device (for example, a tablet or a smart television) generally does not provide a function of detecting temporary leaving of a user and automatic pausing. When the user needs to leave a watching area in front of the playing device because of other things, or needs to turn or lower the head for a relatively long time, in order not to miss video content, the user has to manually stop video playing, which is quite inconvenient. Therefore, it is desired to propose a method for automatically controlling a video playing process according to behaviors of the user.

Face recognition is a biological recognition technology for identity recognition based on face characteristic information of a person. There exist a range of related technologies for collecting an image or video stream containing a face by using a camera or a video camera, automatically detecting and tracing the face in the image, and thereby performing face recognition on the detected face. By means of existing face recognition technologies, a position and an orientation of a face of a user can be relatively accurately determined, and by monitoring the position and the orientation of the face of the user, a behavior of the user can be relatively accurately determined, thereby providing references for video playing control.

### SUMMARY

In view of this, an objective of some embodiments of the present disclosure is to provide a playing control method and playing terminal based on face recognition.

Based on the foregoing objective, the playing control method based on face recognition provided in some embodiments of the present disclosure includes the following steps:

collecting a face image;

analyzing the face image, and extracting a central position of a face in the face image;

comparing the current central position and an initial central position before the first time interval to obtain a movement displacement; and

determining whether the movement displacement is great than a preset displacement threshold; and

pausing a current video playing process if it is determined that the movement displacement is great than the preset displacement threshold.

In an embodiment, the analyzing the face image, and extracting a central position of a face in the face image includes:

analyzing the image, and extracting positions of pupils in the image;

calculating a pupil distance according to the positions of the pupils; and

determining a position of a central point between the pupils as the central position according to the position of the pupils and the pupil distance.

In an embodiment, after the calculating a pupil distance according to the positions of the pupils, the method further includes:

comparing the current pupil distance and an initial pupil distance before a second time interval to obtain a ratio; and

pausing the current video playing process if the ratio is less than a preset pupil distance threshold.

In an embodiment, after the pausing a current video playing process if it is determined that the movement displacement is great than the preset displacement threshold, the method further includes:

timing a pause time;

if the pause time is great than a preset pause threshold, controlling a playing terminal to enter a dormancy state, and continuing collecting an image of a position in front of the playing terminal when the playing terminal is in the dormancy state; and

if it is determined that the central position enters a preset central area again, controlling the playing terminal to exit the dormancy state.

In an embodiment, after the pausing a current video playing process if it is determined that the movement displacement is great than the preset displacement threshold, the method further includes:

continuing collecting a face image;

if it is detected that the face appears in the face image, analyzing the face image, and extracting a central position of the face in the face image;

comparing the current central position and an initial central position before the first time interval to obtain a movement displacement; and

determining whether the movement displacement is less than a preset displacement threshold, and continuing the video playing process if it is determined that the movement displacement is less than the preset displacement threshold.

In an embodiment, after the pausing current video playing, the method further includes:

continuing the video playing process if a control signal for continuing playing is detected.

Some embodiments of the present disclosure further provide a playing terminal based on face recognition, including:

a collection unit, configured to collect a face image;

a processing unit, configured to: analyze the face image, and extract a central position of a face in the face image; compare the current central position and an initial central position before a first time interval to obtain a movement displacement; determine whether the movement displacement is great than a preset displacement threshold; and

a control unit, configured to pause a current video playing process if it is determined that the movement displacement is great than the preset displacement threshold.

In an embodiment, the processing unit is further configured to: analyze the image, and extract positions of pupils in the image; calculate a pupil distance according to the positions of the pupils; and determine a position of a central point between the pupils as the central position according to the position of the pupils and the pupil distance.

In an embodiment, the processing unit is further configured to compare the current pupil distance and an initial pupil distance before a second time interval to obtain a ratio; and the control unit is configured to pause current video playing if the ratio is less than a preset pupil distance threshold.

In an embodiment, the processing unit is further configured to time a pause time; if the pause time is great than a preset pause threshold, the control unit is configured to control the playing terminal to enter a dormancy state, and the collection unit continues collecting an image of a position in front of the playing terminal when the playing terminal is in the dormancy state; and if it is determined that the central position enters a preset central area again, the control unit is configured to control the playing terminal to exit the dormancy state.

In an embodiment, after pausing current video playing, the collection unit is configured to continue collecting a face image; if the processing unit detects that the face appears in the face image, the processing unit analyzes the face image, and extracts a central position of the face in the face image, compares the current central position and an initial central position before the first time interval to obtain a movement displacement, and determines whether the movement displacement is less than a preset displacement threshold; and the control unit is configured to continue the video playing process if it is determined that the movement displacement is less than the preset displacement threshold.

In an embodiment, the terminal further includes a receiving unit, configured to receive an external control signal; and the control unit is configured to continue the video playing process if a control signal for continuing playing is detected.

It can be seen from the description above that, according to the playing control method and playing terminal based on face recognition provided in some embodiments of the present disclosure, a watching position of a user is determined by monitoring a displacement and turning of a face, and after it is detected that the user leaves a normal watching position, playing of a video file is paused, which thereby implements an automatic control process for video playing, and provides convenience for the video user.

### BRIEF DESCRIPTION OF THE DRAWINGS

FIG. 1 is a flowchart of a playing control method based on face recognition according to a first embodiment of the present disclosure;

FIG. 2 is a flowchart of a playing control method based on face recognition according to a second embodiment of the present disclosure;

FIG. 3 is a flowchart of a playing control method based on face recognition according to a third embodiment of the present disclosure;

FIG. 4 is a flowchart of a playing control method based on face recognition according to a fourth embodiment of the present disclosure;

FIG. 5 is a flowchart of a playing control method based on face recognition according to a fifth embodiment of the present disclosure;

FIG. 6 is a flowchart of a playing control method based on face recognition according to a sixth embodiment of the present disclosure; and

FIG. 7 is a block diagram of an embodiment of a playing terminal based on face recognition according to the present disclosure.

### DETAILED DESCRIPTION

To make the objectives, technical solutions, and advantages of some embodiments of the present disclosure clearer, the present disclosure is described in further detail in combination with specific embodiments with reference to the accompanying drawings.

### Embodiment 1

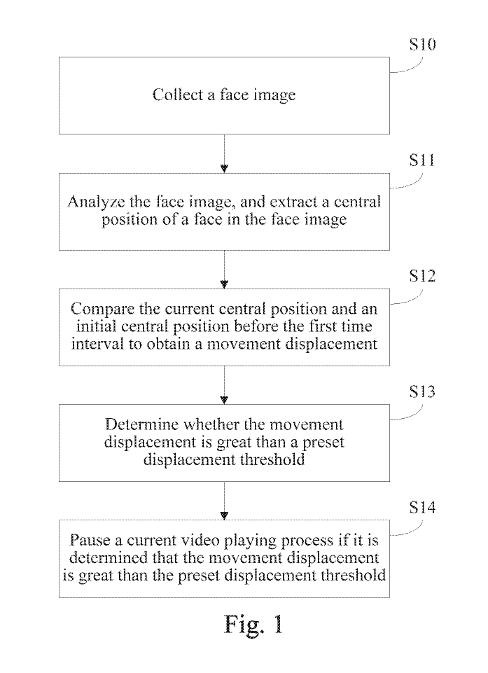

FIG. 1 is a flowchart of a playing control method based on face recognition according to a first embodiment of the present disclosure. As shown in the figure, the playing control method based on face recognition in this embodiment includes the following steps:

S10: Collect a face image.

A method used for collecting the face image includes face recognition based on visible light, three-dimension image face recognition, thermal imaging face recognition, and multi-source face recognition technology based on active infrared imaging, and also includes other face recognition technologies used in the prior art.

S11: Analyze the face image, and extract a central position of a face in the face image.

Characteristics of the face are obtained by analyzing the face image, and the central position in the face image is obtained according to the characteristics. Specific implementation schemes are listed and described below.

S12: Compare the current central position and an initial central position before the first time interval to obtain a movement displacement.

The first time interval is determined after experiments according to an actual condition, and a preferable range is 5 s to 20 s. In another optional embodiment, a value of the first time interval is an adjustable value for manual selection and setting by a user when configuring a playing terminal.

The comparison process in step S12 is implemented periodically at a time interval, where a specific time interval is preset according to a need, and is preferably assigned a value the same as that of the foregoing first time interval. Therefore, the foregoing current central position is a central position when the current comparison is performed, and the initial central position is a central position at a time point that is traced back to from a current time point by the first time interval.

A value of the movement displacement is a positive value, and during calculation, an absolute value of a resulted distance difference is obtained so as to obtain the movement displacement.

S13: Determine whether the movement displacement is great than a preset displacement threshold.

The displacement threshold is preset according to characteristics such as a resolution of a face image collection apparatus. For example, for a collection apparatus having a collection resolution of 1600×900, the displacement threshold may be set to 600 to 1000 pixels. In a preferable implementation manner, a distance between the user and a playing terminal may further be considered. For example, a normal watching distance set by the user is 10 m, and in this case the displacement threshold is set to 800 pixels, then when the user changes the watching distance to 12 m, the displacement threshold may be correspondingly reduced, for example, to 700 pixels, so as to ensure that an actual displacement distance of the user can be identified as accurately as possible.

S14: Pause a current video playing process if it is determined that the movement displacement is great than the preset displacement threshold. If it is determined that the movement displacement is not great than the preset displacement threshold, return to step S10, and continue collecting a face image for next comparison.

In another optional embodiment, if it is determined that the face has already left from the position in front of the terminal, that is, disappears from a face image collection area, the current video playing is also paused.

It is to be noted that, all expressions using “first” and “second” in some embodiments of the present disclosure are for differentiating two different entities or different parameters having a same name. Therefore, “first” and “second” are for purpose of convenient expression, and should not be understood as limitation to the embodiments of the present disclosure, which is not described herein again in subsequent embodiments.

### Embodiment 2

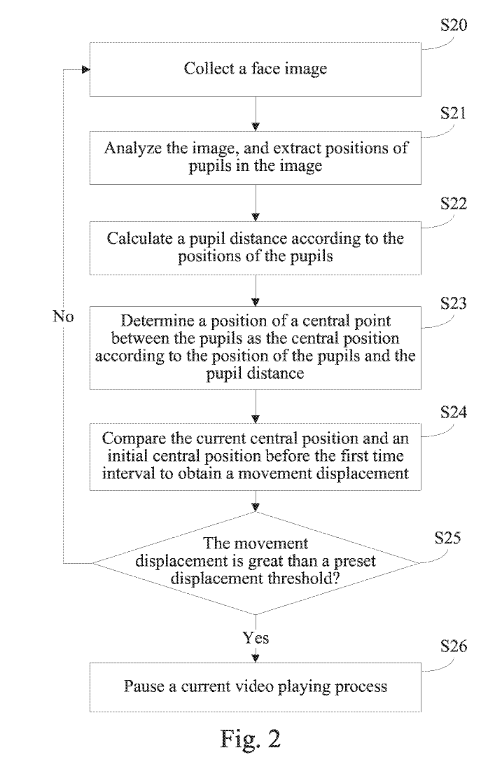

FIG. 2 is a flowchart of a playing control method based on face recognition according to a second embodiment of the present disclosure. This embodiment further describes a method for determining the central position of the face in the foregoing step.

In this embodiment, for the foregoing S11, the analyzing the face image, and extracting a central position of a face in the face image specifically includes:

S21: Analyze the image, and extract positions of pupils in the image.

Existing face recognition technologies can implement recognizing positions of pupils in a face, and especially easily distinguishing the pupils. Therefore, in this embodiment, eye pupils are used as a reference for determining the central position of the face.

S22: Calculate a pupil distance according to the positions of the pupils.

S23: Determine a position of a central point between the pupils as the central position according to the position of the pupils and the pupil distance.

In this determining method, a middle point between eyes is used as the central position of the face, which can better determine a position of the face, and determine a displacement of the watcher, and is especially convenient for calculation.

In other optional implementation manners, the central position of the face may also be determined in other manners. For example, an outline of the entire face is selected, and a center of the outline is determined through calculation.

### Embodiment 3

In addition to the case in which the user leaves from the position in front of the playing terminal, there exists another case, that is, the user lowers the head or turns the head. In this case, it is a relatively appropriate manner for the playing terminal to pause playing, wait for the user to return to the normal position, and then continue playing. Therefore, another embodiment is provided.

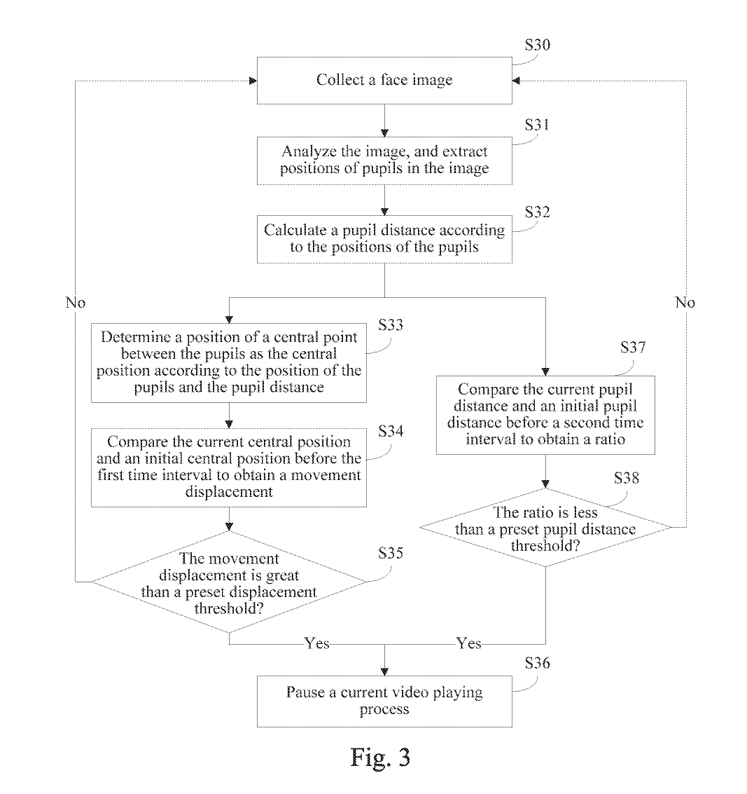

FIG. 3 is a flowchart of a playing control method based on face recognition according to a third embodiment of the present disclosure.

This embodiment includes the following steps.

In this embodiment, after step S32, that is, calculating a pupil distance according to the positions of the pupils, the method further includes:

S37: Compare the current pupil distance and an initial pupil distance before a second time interval to obtain a ratio.

S38: Pause the current video playing process if the ratio is less than a preset pupil distance threshold. If the ratio is not less than the preset pupil distance threshold, return to step S30, and continue collecting a face image for next comparison.

The second time interval is determined after experiments according to an actual condition, and a preferable range is 5 s to 20 s. In another optional embodiment, a value of the second time interval is an adjustable value for manual selection and setting by the user when configuring the playing terminal. Preferably, the second time interval may have a same value as the first time interval.

The ratio is a ratio that is obtained by using the current pupil distance as a numerator, and the pupil distance before the second time interval is used as a denominator. A pupil distance when the user turns the head is the foregoing current pupil distance. The pupil distance before the second time interval is a pupil distance during normal watching. A value change of the pupil distance is a value by which the current pupil distance is less than the pupil distance before the second time interval. Therefore, the foregoing ratio may be 1/3, even 1/4, and therefore, by setting the ratio threshold to 1/2 or another relatively appropriate value less than 1, it can be determined whether the user turns the head, and thereby video playing is paused. If the pupils of the user disappear from the face image collection area, there may be two cases, one of which is that the user has left the face image collection area. The other is that the user lowers the head, which causes that characteristics of the pupils cannot be identified. Regardless which case it is, video playing should be paused. In this case, the current pupil distance may be set to a minimal value, so that the foregoing ratio is certainly less than the ratio threshold, and video playing is still paused.

It is to be noted that, this embodiment may be implemented independently, or may be implemented in combination with the foregoing second embodiment, by which both the central position displacement and the pupil distance change are calculated, and whether the user is in the normal watching position is determined combinatively, and thereby a more accurate result is obtained.

### Embodiment 4

In some cases, if the user leaves for too long, in addition to pausing video playing, the playing terminal may further be caused to enter a dormancy state. Therefore the following embodiment is given.

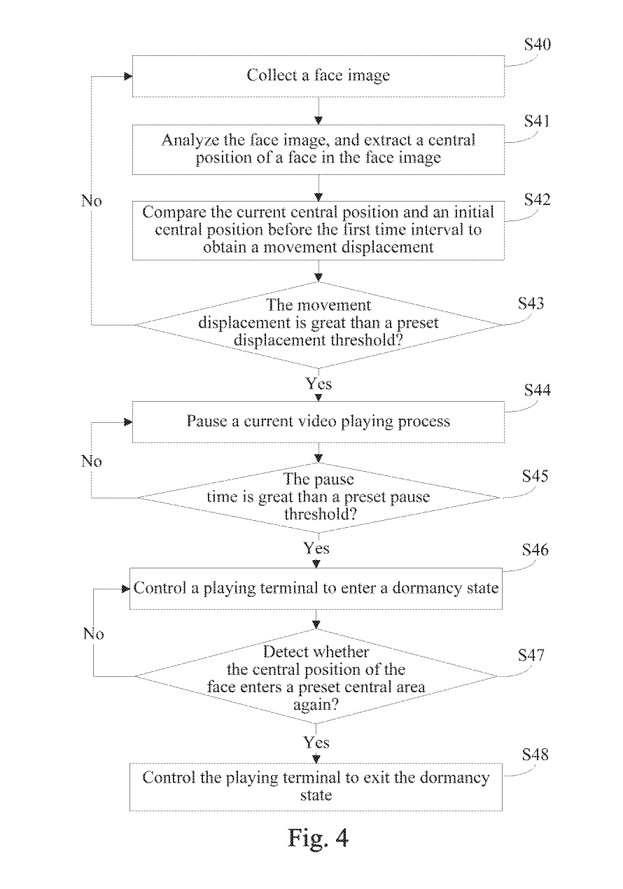

FIG. 4 is a flowchart of a playing control method based on face recognition according to a fourth embodiment of the present disclosure. As shown in the figure, in this embodiment, after step S44, that is, pausing current video playing, the method further includes:

S45: Time a pause time, and determine whether the pause time is great than a preset pause threshold.

S46: If the pause time is great than a preset pause threshold, control a playing terminal to enter a dormancy state, and continue collecting an image of a position in front of the playing terminal when the playing terminal is in the dormancy state; and if the pause time is not great than the preset pause threshold, continue pausing, and continue timing the pausing time, so as to perform determining by repeating step S45 after a time interval.

S47: Detect whether the central position of the face enters a preset central area again.

S48: If it is detected that the central position enters the central area, control the playing terminal to exit the dormancy state. If it is not detected that the central position enters the central area, proceed to step S46, that is, controlling the playing terminal to continue to be in the dormancy state, and periodically repeating step S47.

The foregoing steps are mainly for the case in which the user leaves temporarily. That is, preferably, the foregoing steps are used in combination with the second embodiment. For the third embodiment, the user generally turns or lowers the head only temporarily, and therefore it is not needed to control the playing terminal to enter the dormancy state. Certainly, if it is needed, the entering a dormancy state and timing may be combined with the third embodiment, and a control method for exit the dormancy state is similar to the steps of resuming playing in the third embodiment.

The central area is an area manually set in the face image collection area. That is, when the central position of the face is detected in this central area again, it is determined that the user returns to the position in front of the playing terminal, and in this case the video playing process is continued.

### Embodiment 5

The foregoing embodiment explains and describes how to implement automatically pausing the video playing process when the user temporarily leaves according to the method provided in the present disclosure. In another optional embodiment, a method for determining that the user returns and automatically continuing the video playing process is further provided.

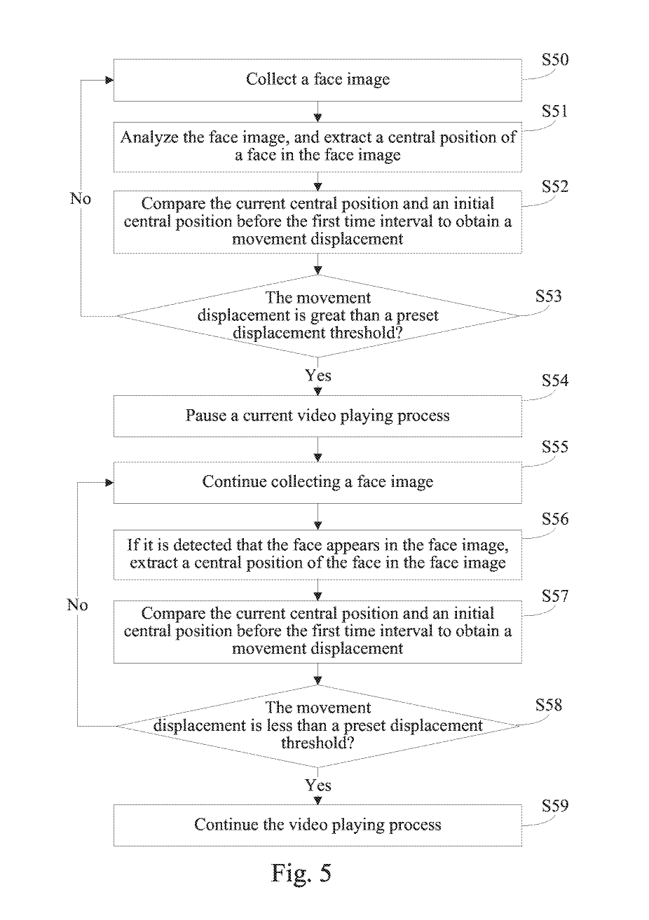

FIG. 5 is a flowchart of a playing control method based on face recognition according to a fifth embodiment of the present disclosure. As shown in the figure, in this embodiment, after step S54, that is, pausing current video playing if it is determined that the movement displacement is great than the preset displacement threshold, the method further includes:

S55: Continue collecting a face image.

S56: If it is detected that the face appears in the face image, analyze the face image, and extract a central position of the face in the face image.

S12: Compare the current central position and an initial central position before the first time interval to obtain a movement displacement.

S58: Determine whether the movement displacement is less than a preset displacement threshold.

S59: Continue the video playing process if it is determined that the movement displacement is less than the preset displacement threshold. If the movement displacement is not less than the preset displacement threshold, proceed to step S55 to continue collecting a face image.

The foregoing steps S55 to S59 implement the following determining process: detecting whether the user returns to a normal watching range (S55 to S56), further determining whether a position of the user is steady according to whether a displacement of the user during a time is less than a threshold (S57 to S59), and thereby determining whether to continue the video playing process. This determining manner is relatively accurate. When the user walks in front of the image collection device but does not stay, video playing is not automatically started.

Optionally, a “triggering area” may also be specially divided in the collection area for the face image collection device, and preferably, the triggering area is set in the center of the collection area. When it is detected that the face appears in this triggering area again, the video playing process is continued; or when it is detected that the face appears in this triggering area again, it is further detected whether the central position of the face maintains to be in the triggering area for a time, and a determining manner is similar to that in the foregoing steps S55 to S59. According to this embodiment, whether the user returns can be determined, and the image collection and analysis area has been set. A processing speed is relatively fast, but a determining range is relatively small, which is suitable for a case in which the watching are is fixed.

### Embodiment 6

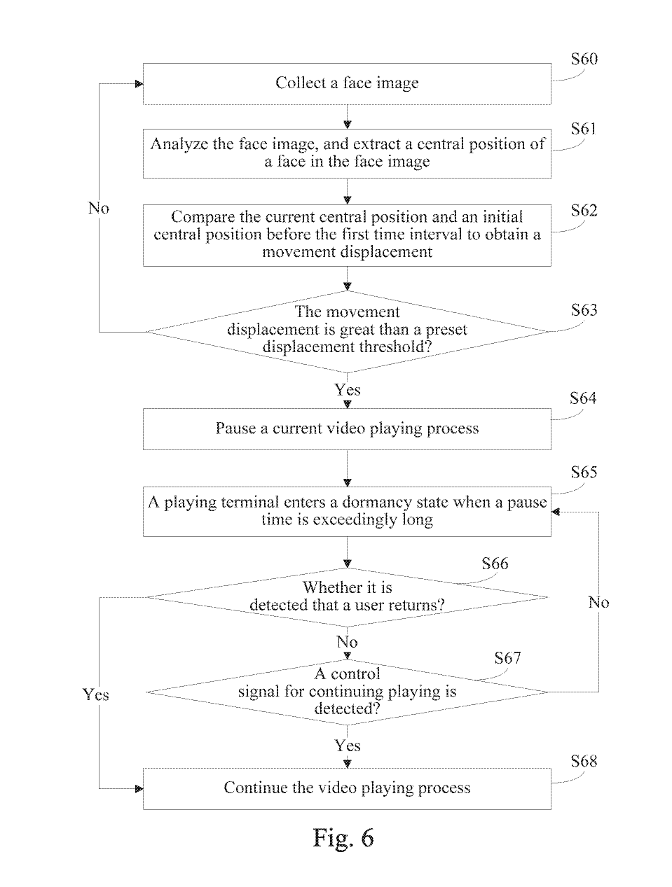

FIG. 6 is a flowchart of a playing control method based on face recognition according to a sixth embodiment of the present disclosure. As shown in the figure, in another optional embodiment, the method further includes:

S67: Detect a control signal for continuing playing.

S68: Continue the video playing process if the control signal for continuing playing is detected. If the control signal is not detected, return to step S65, that is, continuing controlling the playing terminal to be in the dormancy state and continually detecting an external signal.

The control signal may be sent by a dedicated remote control apparatus, or may be sent by another device (for example, sent by an intelligent terminal through a network, certainly provided that the playing device is provided with a networking function).

This embodiment may be implemented independently, or may be implemented in combination with the foregoing fifth embodiment to implement continuing video playing by using multiple methods. The present disclosure further provides a playing terminal corresponding to the foregoing method, and the playing terminal is described below by using an embodiment.

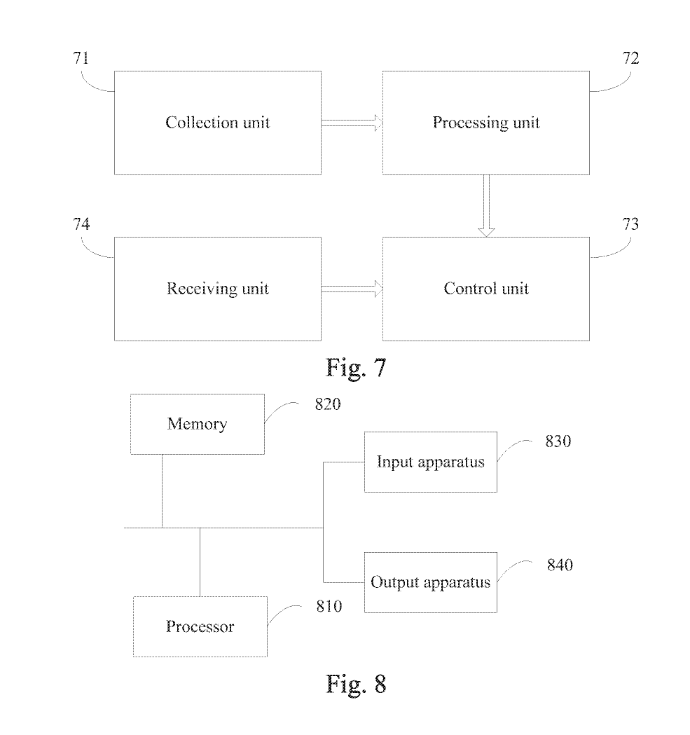

FIG. 7 is a block diagram of an embodiment of a playing terminal based on face recognition according to the present disclosure. As shown in the figure, the playing terminal includes:

a collection unit 71, configured to collect a face image;

a processing unit 72, configured to: analyze the face image, and extract a central position of a face in the face image; compare the current central position and an initial central position before a first time interval to obtain a movement displacement; determine whether the movement displacement is great than a preset displacement threshold; and

a control unit 73, configured to pause a current video playing process if it is determined that the movement displacement is great than the preset displacement threshold.

In an implementation manner, the processing unit 72 is further configured to: analyze the image, and extract positions of pupils in the image; calculate a pupil distance according to the positions of the pupils; and determine a position of a central point between the pupils as the central position according to the position of the pupils and the pupil distance.

In an embodiment, the processing unit 72 is further configured to compare the current pupil distance and an initial pupil distance before a second time interval to obtain a ratio; and the control unit is configured to pause current video playing if the ratio is less than a preset pupil distance threshold.

In an embodiment, the processing unit 72 is further configured to time a pause time; if the pause time is great than a preset pause threshold, the control unit 73 is configured to control the playing terminal to enter a dormancy state, and the collection unit 71 continues collecting an image of a position in front of the playing terminal when the playing terminal is in the dormancy state; and if it is determined that the central position enters a preset central area again, the control unit 73 is configured to control the playing terminal to exit the dormancy state.

In an embodiment, after pausing current video playing, the collection unit 71 is configured to continue collecting a face image; if the processing unit 72 detects that the face appears in the face image, the processing unit 72 analyzes the face image, and extracts a central position of the face in the face image, compares the current central position and an initial central position before the first time interval to obtain a movement displacement, and determines whether the movement displacement is less than a preset displacement threshold; and the control unit 73 is configured to continue the video playing process if it is determined that the movement displacement is less than the preset displacement threshold.

In an embodiment, the terminal further includes a receiving unit 74, configured to receive an external control signal; and the control unit 73 is configured to continue the video playing process if a control signal for continuing playing is detected.

It can be seen from the description above that, according to the playing control method and playing terminal based on face recognition provided in some embodiments of the present disclosure, a watching position of a user is determined by monitoring a displacement and turning of a face, and after it is detected that the user leaves a normal watching position, playing of a video file is paused, which thereby implements an automatic control process for video playing, and provides convenience for the video user.

It should be understood by a person of ordinary skill in the art that, discussion of any foregoing embodiment is merely exemplary, and is not intended to suggest that the scope of the present disclosure (including the claims) is limited to these examples. According to the concept of the present disclosure, technical features in the foregoing embodiments or different embodiments may also be combined, the steps may be implemented in any order, and many other variations exist for different aspects of the present disclosure described above, and they are not provided in detail for brevity. Therefore, any omission, modification, equivalent replacement, and improvement shall be included within the protection scope of the present disclosure without departing from the spirit and principle of the present disclosure.

1. A playing control method based on face recognition, applied to a terminal, comprising the following steps:
collecting a face image;
analyzing the face image, and extracting a central position of a face in the face image;
comparing the current central position and an initial central position before a first time interval to obtain a movement displacement;
determining whether the movement displacement is great than a preset displacement threshold; and
pausing a current video playing process if it is determined that the movement displacement is great than the preset displacement threshold.

2. The method according to claim 1, the analyzing the face image, and extracting a central position of a face in the face image comprises:
analyzing the image, and extracting positions of pupils in the image;
calculating a pupil distance according to the positions of the pupils; and
determining a position of a central point between the pupils as the central position according to the position of the pupils and the pupil distance.

3. The method according to claim 2, wherein after the calculating a pupil distance according to the positions of the pupils, the method further comprises:
comparing the current pupil distance and an initial pupil distance before a second time interval to obtain a ratio; and
pausing the current video playing process if the ratio is less than a preset pupil distance threshold.

4. The method according to claim 1, wherein after the pausing a current video playing process if it is determined that the movement displacement is great than the preset displacement threshold, the method further comprises:
timing a pause time;
if the pause time is great than a preset pause threshold, controlling a playing terminal to enter a dormancy state, and continuing collecting an image of a position in front of the playing terminal when the playing terminal is in the dormancy state; and
if it is determined that the central position enters a preset central area again, controlling the playing terminal to exit the dormancy state.

5. The method according to claim 1, wherein after the pausing current video playing if it is determined that the movement displacement is great than the preset displacement threshold, the method further comprises:
continuing collecting a face image;
if it is detected that the face appears in the face image, analyzing the face image, and extracting a central position of the face in the face image;
comparing the current central position and an initial central position before the first time interval to obtain a movement displacement; and
determining whether the movement displacement is less than a preset displacement threshold, and continuing the video playing process if it is determined that the movement displacement is less than the preset displacement threshold.

6. The method according to claim 3, wherein after the pausing current video playing, the method further comprises:
continuing the video playing process if a control signal for continuing playing is detected.

7-12. (canceled)

13. A non-volatile computer storage medium, which stores a computer executable instruction, that when executed by an electronic device, cause the electronic device to:
collect a face image;
analyze the face image, and extract a central position of a face in the face image;
compare the current central position and an initial central position before a first time interval to obtain a movement displacement;
determine whether the movement displacement is great than a preset displacement threshold; and
pause a current video playing process if it is determined that the movement displacement is great than the preset displacement threshold.

14. The non-volatile computer storage medium according to claim 13, the instructions to analyze the face image, and extracting a central position of a face in the face image cause the electronic device to:
analyze the image, and extracting positions of pupils in the image;
calculate a pupil distance according to the positions of the pupils; and
determine a position of a central point between the pupils as the central position according to the position of the pupils and the pupil distance.

15. The non-volatile computer storage medium according to claim 14, wherein after the calculating a pupil distance according to the positions of the pupils, the electronic device is further caused to:
compare the current pupil distance and an initial pupil distance before a second time interval to obtain a ratio; and
pause the current video playing process if the ratio is less than a preset pupil distance threshold.

16. The non-volatile computer storage medium according to claim 13, wherein after the instructions to pause a current video playing process if it is determined that the movement displacement is great than the preset displacement threshold, the electronic device is further caused to:
time a pause time;
if the pause time is great than a preset pause threshold, control a playing terminal to enter a dormancy state, and continue collecting an image of a position in front of the playing terminal when the playing terminal is in the dormancy state; and
if it is determined that the central position enters a preset central area again, control the playing terminal to exit the dormancy state.

17. The non-volatile computer storage medium according to claim 13, wherein after the instructions to pause current video playing if it is determined that the movement displacement is great than the preset displacement threshold, the electronic device is further caused to:
continue collecting a face image;
if it is detected that the face appears in the face image, analyzing the face image, and extract a central position of the face in the face image;
compare the current central position and an initial central position before the first time interval to obtain a movement displacement; and
determine whether the movement displacement is less than a preset displacement threshold, and continue the video playing process if it is determined that the movement displacement is less than the preset displacement threshold.

18. The non-volatile computer storage medium according to claim 15, wherein after the instructions to pause current video playing, the electronic device is further caused to:
continue the video playing process if a control signal for continuing playing is detected.

19. An electronic device, comprising:
at least one processor; and
a memory communicably communication with the at least one processor, wherein
the memory stores instructions executable by the at least one processor, wherein
execution of the instructions by the at least one processor causes the at least one processor to:
collect a face image;
analyze the face image, and extract a central position of a face in the face image;
compare the current central position and an initial central position before a first time interval to obtain a movement displacement;
determine whether the movement displacement is great than a preset displacement threshold; and
pause a current video playing process if it is determined that the movement displacement is great than the preset displacement threshold.

20. The electronic device according to claim 19, the execution of the instructions to analyze the face image, and extracting a central position of a face in the face image cause the at least one processor to:
analyze the image, and extracting positions of pupils in the image;
calculate a pupil distance according to the positions of the pupils; and
determine a position of a central point between the pupils as the central position according to the position of the pupils and the pupil distance.

21. The electronic device according to claim 20, wherein after the execution of the instructions to calculate a pupil distance according to the positions of the pupils, the at least one processor is further caused to:
compare the current pupil distance and an initial pupil distance before a second time interval to obtain a ratio; and
pause the current video playing process if the ratio is less than a preset pupil distance threshold.

22. The electronic device according to claim 19, wherein after the execution of the instructions to pause a current video playing process if it is determined that the movement displacement is great than the preset displacement threshold, the at least one processor is further caused to:
time a pause time;
if the pause time is great than a preset pause threshold, control a playing terminal to enter a dormancy state, and continue collecting an image of a position in front of the playing terminal when the playing terminal is in the dormancy state; and
if it is determined that the central position enters a preset central area again, control the playing terminal to exit the dormancy state.

23. The electronic device according to claim 19, wherein after the execution of the instructions to pause current video playing if it is determined that the movement displacement is great than the preset displacement threshold, the at least one processor is further caused to:
continue collecting a face image;
if it is detected that the face appears in the face image, analyzing the face image, and extracting a central position of the face in the face image;
compare the current central position and an initial central position before the first time interval to obtain a movement displacement; and
determine whether the movement displacement is less than a preset displacement threshold, and continuing the video playing process if it is determined that the movement displacement is less than the preset displacement threshold.

24. The electronic device according to claim 20, wherein after the execution of the instructions to pause current video playing, the at least one processor is further caused to:
continue the video playing process if a control signal for continuing playing is detected.
